(19) United States
(12) Patent Application Publication
(10) Pub. No.: US 2004/0252866 A1
(43) Pub. Date: Dec. 16, 2004

(54) Generation of a typical image restored from a set of several images showing the same element

(76) Inventors: Christel-Loic Tisse, Plan De Cuques (FR); Guillaume Petitjean, Trets (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/864,162

(22) Filed: Jun. 9, 2004

(30) Foreign Application Priority Data
Jun. 10, 2003 (FR) 03/06928

(51) Int. Cl. G06K 9/00; G06K 9/40

(52) U.S. Cl. 382/117; 382/254

(57) ABSTRACT

A method for generating a typical image including at least three values per pixel, based on a set of binary images all showing a same element, including: summing up the binary values of the pixels of same coordinates in the set of binary images; generating a first state in the typical image if the sum of the pixels of same coordinates of the binary images provides a value smaller than a first threshold; and generating a second state in the typical image if the sum of the pixels of same coordinates of the binary images provides a value greater than a second threshold.

### BACKGROUND OF THE INVENTION

1. Field of the Invention

The present invention relates to the generation of a digital image based on a set of binary images all showing the same element.

2. Discussion of the Related Art

An example of application of the present invention is the coding of a typical restored image, representative of the iris of an eye in a recognition process. It may either be the generation based on several views of a same reference typical image with which current images are to be compared, or a current typical image which must be compared with a reference image, whether the latter is or not generated by the system of the present invention.

An iris is characterized by its structure, which is an assembly of three-dimensional hole and bump patterns, each pattern having in the iris a radial direction. Such a texture translates, upon bidimensional digital acquisition of images, by the alternation of light and dark areas. The texture variation in the iris from the pupil edge to the cornea according to the direction is very small. The information characteristic of the iris texture essentially varies in the angular position of concentric circles.

To enable relatively fast iris recognition, rather than comparing point-by-point a processed image with reference images, the iris texture is generally extracted to obtain a generally elongated rectangular binarized image. This shape results from an unfolding of the ring representative of the iris in the eye, after the processing applied to the image.

The general ring shape of the iris is transformed in straight rectangular form by converting the Cartesian coordinates of the iris into polar coordinates by means of a constant angle polar conversion. The image further undergoes several processing, among which at least one binarization processing to obtain an image in which each of the pixels is coded by 0 or 1 only.

This binarized image is then generally compared with an image (reference or current image).

Generally, the comparison of a current image with a reference image is then performed by simple XOR-type bit-to-bit logic combination.

A problem which is posed in the acquisition of such images and especially for the iris recognition processing is due to uncertainties upon acquisition resulting, for example, from eye motions or tasks linked to the lighting upon shooting.

It can be seen that in case of an imperfect acquisition, a bit-to-bit comparison is poorly reliable.

Examples of iris coding method for use in recognition processes are described, for example, in European patent application No. 1304647.

### SUMMARY OF THE INVENTION

The present invention aims at improving the possible exploitation of current or reference images representative of the iris of an eye.

The present invention more specifically aims at overcoming the lack of reliability of the comparison results linked to the imperfection of the images upon acquisition thereof.

The present invention also aims at providing a particularly simple method, which is compatible with binary image processings.

The present invention also aims at requiring no modification of conventional methods for obtaining conventional unfolded binarized images.

To achieve these and other objects, the present invention provides a method for generating a typical image comprising at least three values per pixel, based on a set of binary images all showing a same element, consisting of:

summing up the binary values of the pixels of same coordinates in the set of binary images;

generating a first state in the typical image if the sum of the pixels of same coordinates of the binary images provides a value smaller than a first threshold; and

generating a second state in the typical image if the sum of the pixels of same coordinates of the binary images provides a value greater than a second threshold.

According to an embodiment of the present invention, the first threshold ranges between 0 and n/4, where n designates the number of binary images.

According to an embodiment of the present invention, the second threshold ranges between 3n/4 and 1, where n designates the number of binary images.

According to an embodiment of the present invention, the first and second thresholds are respectively 0 and 1.

According to an embodiment of the present invention, the restored typical image contains, for each pixel, the value of the sum of the pixels of the original images.

According to an embodiment of the present invention, the restored typical image contains a value representing an undetermined state for each pixel, said sum of which ranges between said thresholds.

The present invention also provides a method for comparing a current image with a reference image, at least one of the images being a restored typical image.

According to an embodiment of the present invention, the images originate from digital views of the iris of an eye.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 illustrates the image type obtained in an iris ring binarization method; and

FIG. 2 illustrates, in the form of blocks, an implementation mode of the method of the present invention.

### DETAILED DESCRIPTION

For clarity, only those elements necessary to the understanding of the present invention have been shown in the drawings and will be described hereafter. In particular, the obtaining of the binary images to be exploited for the generation of an image according to the present invention has not been detailed, the present invention being implementable from any set of conventional binarized images. Further, the tools usable for the implementation of the present invention have not been shown, the present invention being implementable with conventional iris image exploitation tools and, in particular, computer systems.

A feature of the present invention is to restore a typical image comprising at least three values per pixel, based on a set of binary images in which each pixel is coded in the form of a single bit.

The present invention will be described hereafter in relation with an example of application to the generation of an iris image. It should however be noted that it more generally applies as soon as a typical image is desired to be generated from a set of binary images showing the same thing, to avoid the imperfections of individual images, whether such imperfections are due to the actual shooting operations or to the subsequent processing resulting in the image binarization.

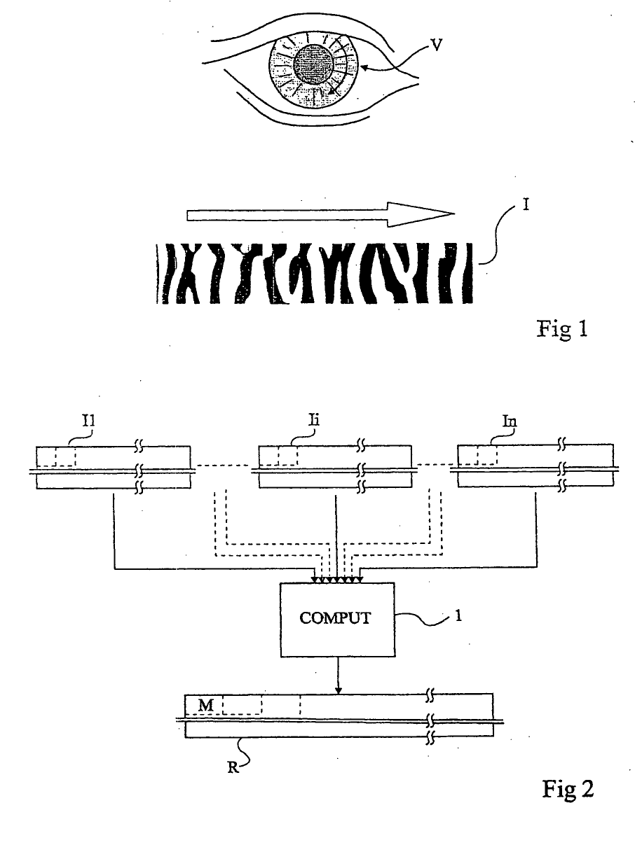

FIG. 1 illustrates an example of a binary image I likely to be exploited by the present invention. This example is an application to iris images. Binary image I is obtained by unfolding and filtering and binarization processing of a view V of an iris as illustrated in FIG. 1. The extraction of image I from view V is conventional. In FIG. 1, the image unfolding direction has been shown with arrows.

FIG. 2 illustrates in the form of blocks an embodiment of the method for generating a restored typical image R from a set of several binary images I1, . . . , Ii, . . . , In.

According to the present invention, it is started from a set of n images which are, preferably, individually centered back in translation to compensate for possible shooting differences by rotation of the eye. Such a centering is performed by applying, to image set I, a step of comparison by minimum error search between the different images. For example, such a minimum error search uses algorithms implementing a Hamming distance. Such methods of centering back by image translation are known, for example, from U.S. patent application No. 2003-0076984.

The step of centering back in translation of course results in a loss of the edges of images I once centered back. However, and especially in the application to the iris image processing, it is considered that the average rotational displacement of the eye from one image to another is more or less 7 degrees. For an image width generally of 512 pixels, the edge loss due to the centering is negligible.

In a second step illustrated in FIG. 2 by a block 1 (COMPUT), a sum is calculated pixel per pixel over the n images. A number between 0 and n is then obtained for each position (pixel) in the image.

The restored typical image has the same size (same number of pixels) as the original images (neglecting the edge suppression).

The generation of result typical image R, to obtain a reliable image for a subsequent implementation of a recognition process, consists of exploiting the results of the sum of the pixels of the n images. Indeed, if a resulting pixel has a zero value or a value close to 0, this means that most of the n images have a zero value at this position. Accordingly, it can be considered that at this position (image pixel), there is a reliable 0 in the binarized image. Similarly, if the resulting number of a given pixel is close to n, it can be considered that there is a reliable state 1.

In a simplified embodiment, a typical image R comprising, for each pixel, a data word M (of at least 2 bits) containing at least three values per pixel is then obtained. These values are 0, 1, and an undetermined state for the pixels, the result of which is considered by block 1 as being unreliable.

Ideally, the maximum reliability of an image is given by only considering as reliable the pixels for which the sums of the values pixel to pixel over the n images provide the same result (that is, values 0 and n). However, such a reliability risks being obtained at the cost of too strong a loss of significant pixels in the restored image, thus preventing subsequent recognition.

To solve this problem, thresholds of acceptation of values 0 and 1 are determined. For example, if the result ranges between 0 and n/4, it is considered that there is a reliable 0. If, however, the result ranges between 3n/4 and 1, it is considered that there is a reliable state 1. Between the two, the state is considered to be undetermined, and thus unreliable.

As an alternative, words M of more than two bits may be used to keep in the result image the integrality of the pixel distribution. However, this is not a preferred embodiment since the obtained image is most often intended to be compared with another image to detect the coincidence between the white and black levels and not in terms of grey levels.

According to the present invention, the method for obtaining a typical image of at least three values from a set of binary images may apply to enrollment, that is, the initial memorization of a reference image of an iris based on several views, as well as to a set of views of a current image intended to be afterwards compared with a reference image, whether the latter has or not been enrolled with the method of the present invention.

The step of comparison between two images is then performed, for example, and conventionally, by only accepting the identity between two states 0 or the identity between two states 1. The third states (or the other states) of the typical image of the present invention then result in the obtaining of a state 0, indicative of no identity in the comparison result.

As an alternative, weighting coefficients may be assigned in case of no identity between the two compared elements. For example, a coefficient −1 may be assigned if the states of the compared images are opposite, that is, 0 and 1 or 1 and 0, a 0 may be assigned if the states are between these two values or are undetermined by the method of the present invention, and a 1 may be assigned in case of a two-by-two identity.

Of course, the present invention is likely to have various alterations, modifications, and improvement which will readily occur to those skilled in the art. In particular, the selection of the number of values of the typical image restored by the implementation of the present invention is within the abilities of those skilled in the art based on the application. The obtaining of a three-state image however is a preferred embodiment especially for the application to iris image recognition. Further, the initial image centering step is optional, especially if the views or the initial processings of the images to obtain the binary image set take such a centering into account. Further, a threshold setting the number of reliable pixels in the typical image short of which it is considered that the typical image generation cannot be retained for a comparison may be provided. In the application to the iris, this threshold is, for example, on the order of half of the image pixels.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for generating a typical image comprising at least three values per pixel, based on a set of binary images all showing a same element, comprising:
summing up the binary values of the pixels of same coordinates in the set of binary images;
generating a first state in the typical image if the sum of the pixels of same coordinates of the binary images provides a value smaller than a first threshold; and
generating a second state in the typical image if the sum of the pixels of same coordinates of the binary images provides a value greater than a second threshold.

2. The method of claim 1, wherein the first threshold ranges between 0 and n/4, where n designates the number of binary images.

3. The method of claim 1, wherein the second threshold ranges between 3n/4 and 1, where n designates the number of binary images.

4. The method of claim 1, wherein the first and second thresholds are respectively 0 and 1.

5. The method of claim 4, wherein the restored typical image contains, for each pixel, the value of the sum of the pixels of the original images.

6. The method of claim 1, wherein the restored typical image contains a value representing an undetermined state for each pixel, said sum of which ranges between said thresholds.

7. A method for comparing a current image with a reference image, wherein at least one of the images is a typical image obtained by the implementation of the method of claim 1.

8. The method of claim 7, wherein the images originate from digital views of the iris of an eye.
